(19) United States
(12) Patent Application Publication
(10) Pub. No.: US 2011/0143704 A1
(43) Pub. Date: Jun. 16, 2011

(54) Specialized dial a chip

(76) Inventor: William Lorentz, W. Haverstraw, NY (US)

(21) Appl. No.: 12/924,012

(22) Filed: Sep. 17, 2010

Related U.S. Application Data
(60) Provisional application No. 61/282,078, filed on Dec. 14, 2009.

(51) Int. Cl. H04M 11/04

(52) U.S. Cl. 455/404.1; 379/37

(57) ABSTRACT

The present invention provides an automated system with which cell phones or land-line phones can be equipped in order to more clearly and easily communicate preset emergency messages to a 911 dispatcher. The Specialized Dial A Chip system includes an S.O.S. button, this button activating the system and allowing the user to enter his or her PIN. Upon entering their PIN, the user is presented with a preset, prerecorded menu of emergency situations, numbered 1 through 9, including such emergencies as house fires, home invasions and robberies, domestic abuse, and so forth, as well as a complete menu of medical emergencies such as cuts, broken limbs, heart attacks and strokes, and so forth.

### CLAIM OF PRIORITY

This patent application claims priority under 35 USC 119 (e) (1) from U.S. Provisional Patent Application Ser. No. 61/282,078 filed Nov. 12, 2009, of common inventorship herewith entitled, “Specialized Dial A Chip.”

### FIELD OF THE INVENTION

The present invention pertains to the field of emergency notification systems, and more specifically to the field of emergency notification systems use din conjunction with a programmed telephone.

### BACKGROUND OF THE INVENTION

The prior art has put forth several designs for emergency notification systems. Among these are:

U.S. Pat. No. 5,333,172 to Michael B. Stevens describes an emergency telephone communications device comprising a system, which notifies emergency personnel with the activation of a switch.

U.S. Pat. No. 5,388,144 to John D. Nichols describes an automatic emergency dialer which dials the number of emergency personnel activated by a smoke alarm or other security system.

U.S. Pat. No. 5,710,803 to Robert Kowal and Donna Kowal describes an emergency phone messaging system comprising a system for dialing and sending a prerecorded message in emergency situations to police, fir department, or ambulance at the push of a single button.

None of these prior art references describe the present invention.

### SUMMARY OF THE INVENTION

It is an object of the present invention to provide an improved system for notification of emergency personnel in a variety of emergency situations.

### BRIEF DESCRIPTION OF THE DRAWINGS

FIG. 1 is a perspective view of the device of the present invention.

FIG. 2 is a close up perspective view of the device of the present invention showing an emergency menu.

FIG. 3 is a close up perspective view showing a removable Braille cover for the device of the present invention.

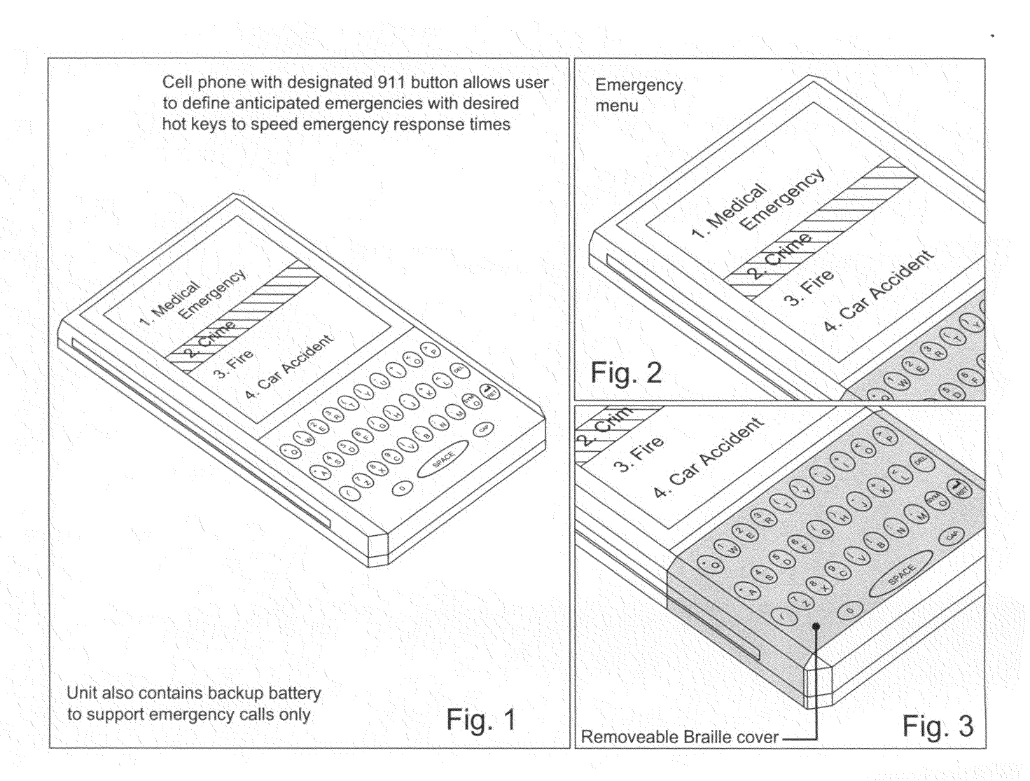

### DETAILED DESCRIPTION OF THE INVENTION

The present invention provides an improvement of the 911 telephone emergency system. Although the 911 system has revolutionized emergency response across the country, communications problems frequently occur between callers and dispatchers. The present invention eliminates some of these problems and is hereinafter referred as The Specialized Dial A Chip.

Simply stated, The Specialized Dial A Chip is an automated system with which cell phones or land-line phones can be equipped in order to more clearly and easily convey information to 911 emergency dispatchers. Manufactured by the Telephone and Telegraph Apparatus Industry, Standard Industrial Category 3663, The . Specialized Dial A Chip can be installed in cell phones or traditional landline phones, and equips them to communicate preset emergency messages to the 911 dispatcher. The Specialized Dial A Chip is a new way to use and get help from 911. The system is installed in cell phones or landline phones, and is programmed by the individual user, the user gaining access to the system through a PIN (Personal Identification Number). The Specialized Dial A Chip system includes an S.O.S. button, this button activating the system and allowing the user to enter his or her PIN. Upon entering their PIN, the user is presented with a preset, prerecorded menu of emergency situations, numbered 1 through 9, including such emergencies as house fires, home invasions and robberies, domestic abuse, and so forth, as well as a complete menu of medical emergencies such as cuts, broken limbs, heart attacks and strokes, and so forth. The present invention also includes the capabilities of book translating, texting and voice recording.

The user selects the relevant emergency message from the phone's recorded menu, and then, by pressing the S.O.S. button a second time, sends this message to the 911 dispatcher. In the case of medical emergencies. The Specialized Dial A Chip system automatically transmits an electronic version of the individual's medical history along with the emergency message. Once the message has been transmitted, it is repeated continuously until the user re-entered their PIN code, and pressed “End Message”. In this manner, should the sender be completely disabled by the emergency, unconscious, immobile, or unable to speak, the emergency signal would repeat until help arrived. The Specialized Dial A Chip system also incorporates a back-up battery, and will continue transmission even if the cell phone battery failed. Also, The Specialized Dial A Chip system can be custom-programmed by the user, who can select the nine most likely emergencies expected to befall them. A diabetic, for example, might program the system differently than a cardiac patient or paraplegic, each user choosing messages most appropriate to their situation.

Use of The Specialized Dial A Chip system is relatively simple and straightforward. The consumer purchases the system, or a phone already equipped with the system, and then follows the instruction manual in programming The Specialized Dial A Chip system as desired. Then, in the event an emergency should occur, the user would employ the system as described above in contacting and transmitting an emergency message to the 911 dispatcher.

The Specialized Dial A Chip system, an automated calling system designed for use in 911 calls, presents a number of distinct benefits and advantages. Foremost, in the stress and confusion of a medical or criminal emergency, many persons who call 911 are too distraught to provide complete and clear information on the nature of the emergency, the location of the emergency, and their own medical condition. The Specialized Dial A Chip system provides a clearer, more easily understood message for the dispatcher, and the dispatcher needs this clarity in order to properly evaluate the emergency and send the appropriate responders such as fire, police, or emergency medical service. Further, in the event of a medical emergency, The Specialized Dial A Chip system not only transmits the emergency message, but also the medical records of the caller, thus preparing emergency medical service personnel in advance, alerting them to any medication, allergies or special conditions that the victim may present. Designed to provide clear and concise information to 911 dispatchers, The Specialized Dial A Chip system transmits this information continuously until the dispatcher acted upon it and help arrived at the caller's location.

A personalized, automated system for making emergency 911 telephone calls clearer and more complete, The Specialized Dial A Chip system is more easily understood by police and emergency medical dispatchers, and easier for consumers as well. A technological advance over existing 911 systems, The Specialized Dial A Chip system will find a wide and receptive market among the nation's household consumers, as well as municipal emergency responders.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. An emergency notification system comprising an automated system for telephones including pre-recorded messages for emergency responders to 911 calls.

2. The system of claim 1 wherein the telephone is a cell phone.

3. The system of claim 1 wherein the telephone is a land line.

4. The system of claim 1 further comprising a means to access the system requiring a personal identification number.

5. The system of claim 4 further comprising an S.O.S. button to activate the system, allowing a user to enter a personal identification number, whereupon the user is presented with a preset, prerecorded menu of emergency situations, numbered 1 through 9.

6. The system of claim 5, wherein the pre-recorded messages include emergencies as house fires, home invasions and robberies, domestic abuse, and medical emergencies.

7. The system of claim 5, wherein pressing the S.O.S. button a second time, sends the message to the emergency responder or 911 dispatcher.

8. The system of claim 6 wherein the system transmits an electronic version of the individual's medical history along with a medical emergency message.
